(19) United States
(12) Patent Application Publication
(10) Pub. No.: US 2010/0199751 A1
(43) Pub. Date: Aug. 12, 2010

(54) FULL BODY PROBE

(75) Inventor: Andre Lechat, Amerchich Marrakech (MA)

Correspondence Address: YOUNG & THOMPSON, 209 Madison Street, Suite 500, Alexandria, VA, 22314, US

(73) Assignee: DATC EUROPE, Besancon (FR)

(21) Appl. No.: 12/527,515

(22) PCT Filed: Feb. 15, 2008
(86) PCT No.: PCT/FR2008/000202

§ 371 Date: Apr. 15, 2010

(30) Foreign Application Priority Data
Feb. 15, 2007 (FR) 07/01115

(51) Int. Cl. G01N 3/40; G01F 23/00

(52) U.S. Cl. 73/84; 73/290 R

(57) ABSTRACT

A geotechnical or geophysical probe (50) of the type including a central probe body (1) for supplying one or more fluids (G, L) using one or more fluid (G, L) supply ducts (40, 41), at least one probe member (21, 22, 23) adjacent to the probe body (1), characterized in that it includes a substantially non-deformable tank (53) for containing additional volumes (Vg, Vl) of a first fluid (L) and a second fluid (G), the volume (Vl) of the first fluid of the tank (53) communicating with at least one first supply duct (40) and the volume of the second fluid (Vg) of the tank (53) being at least connected to a second supply duct (41), wherein the ducts (40, 41) are provided in a solid area of the probe body (1).

The invention relates to a probe, in particular a geotechnical or geophysical probe, and more particularly a probe that can be used in a pressiometer.

Different types of probes that make it possible to determine the characteristics of soil are known. Geotechnical probes are used to determine the technical characteristics of soil, such as, for example, the mechanical strength. Geophysical probes are also used to evaluate the physical and chemical characteristics of soils.

A well-known type of geotechnical probe is the pressiometer probe. A pressiometer is a device that makes it possible to measure in situ the characteristics of strength and deformability of a soil. It consists of a radially dilatable, tricellular cylindrical probe, a set of elements for pneumatic pressurization and regulation, and a volume controller. This device makes it possible to ascertain the increase in the volume of a drilling section as a function of applied pressures.

These pressiometers are well known to one skilled in the art since their invention by L. Ménard in 1955. They are described in particular in the patents FR 1,117,983 and FR 2 766 229.

However, the use of several fluids for expanding the different cells of the tricellular probe requires having for each fluid a tank that is arranged on the surface and connecting said tank to the probe by a pipe. The measurement of the increase in the volume is then disrupted by the weight of each fluid column between the surface and the probe, by the deformation and the differential head of each pipe between the surface and the probe.

In addition, during the installation of the geotechnical or geophysical probes in the soil, during the drilling operation, the traditional probes turn out to be of inadequate strength from a mechanical standpoint, particularly while the probe is being driven in, i.e., when it is subjected to impact or percussion in order for it to be inserted into the soil. The invention proposes a probe that makes it possible to eliminate these drawbacks.

The invention thus has as its object a geotechnical or geophysical probe of the type that comprises a central probe body that is designed to supply, in one or more fluids and using one or more fluid supply pipes, at least one element of the probe that is adjacent to the probe body, noteworthy in that it comprises an essentially non-deformable tank that is designed to contain additional volumes of a first fluid and a second fluid, whereby the volume of the first fluid of the tank is linked with at least one first supply pipe, whereby the volume of the second fluid of the tank is at least connected to the second supply pipe, whereby the pipes are located in a filled zone of the probe body.

The filled zone can be a portion of the probe body, or preferably the probe body itself, so as to better distribute the mechanical forces while the probe is being driven in.

The fluid supply pipe(s) can advantageously be produced by piercing.

The probe body can be cylindrical, i.e., a surface that is produced by the movement of a straight line that always maintains the same orientation and that rests on a closed curve. The curve is preferably a circle.

The cylindrical probe body is advantageously equipped with one or more threaded external zones, so as to facilitate the transmission of impact forces into the probe.

The external threaded zones are preferably arranged at each of the ends of the probe body.

The threads that are used are preferably of the string type. String threading is defined as a set of threads with an essentially sinusoidal or trapezoidal profile.

The string threadings described in the ISO Standard 10208 can be used in particular.

The pitch of the threads is preferably between 10 and 30 mm.

The depth of the threads is preferably between 1 and 5 mm.

The probe according to the invention can be a pressiometric probe. According to this embodiment, the fluid supply pipes comprise a first fluid supply pipe and a second fluid supply pipe, whereby the elements supplied with fluids comprise a central inflatable sleeve, two inflatable sleeves adjacent to the central sleeve and located on both sides of the latter, and whereby the three sleeves surround the probe body, the central sleeve is connected to the first fluid supply pipe, and the sleeves that are adjacent to the central sleeve are connected to the second fluid supply pipe.

The probe therefore comprises a tank that contains additional volumes of gas and liquid, whereby the liquid volume of the tank is linked with the central sleeve via the first fluid supply pipe, and the gas volume of the tank is connected to the second fluid supply pipe. In addition, the tank is adjacent to the body of the probe, advantageously arranged above the probe body when the latter is in an operational configuration and consequently moves simultaneously with said body of the probe. In this way, the supply of the probe, from the surface, no longer requires a liquid pipe but rather a single gas pipe. In addition, the liquid volume is measured in a simple and reliable way because the measurement that is obtained is not disrupted by:
The weight of the liquid column between the surface and the probe in the drilling,
The deformation of the liquid pipe that, in the existing pressiometers, generally connects the first sleeve to the tank that is arranged on the surface,
The inertia that opposes this pipe in the circulation of liquid between the surface and the probe.

The tank can comprise a volume sensor that is suitable for providing a signal that is linked to the volume of the liquid in the tank. The volume sensor can comprise, for example, a liquid level detector.

The liquid level detector can comprise at least one resistive element that is designed to be immersed, at least partially, in the liquid volume of the tank, whereby the resistive element is arranged essentially parallel to the axis of the tank.

In particular, the tank can be cylindrical.

The fluid supply pipe can be connected, in the tank, on the one hand to a first valve that allows the intake of fluid into the tank, and, on the other hand, to a second valve that allows the discharge of fluid outside of the tank.

The valves can comprise a valve body that is equipped with two threaded zones that are separated by a stop, whereby the valve body is extended by a finer tubular element than the valve body and comprises a gas outlet opening that is covered by an elastic cylindrical jacket.

These valves advantageously can be screwed into a threaded zone that is made in a filled zone of the tank.

The invention also has as its object a pressiometer, comprising:
A probe for a pressiometer as described above,
A piece of surface equipment comprising a source of pressurized gas, a pipe that connects the gas source to the tank of the probe, a pressure sensor that is suitable for providing a signal that is linked to pressure in the tank of the probe, and
Means for connecting the probe to the piece of surface equipment.

Other characteristics and advantages of the invention will emerge clearly from the description that is given below, by way of indication and in no way limiting, with reference to the accompanying drawings, in which:

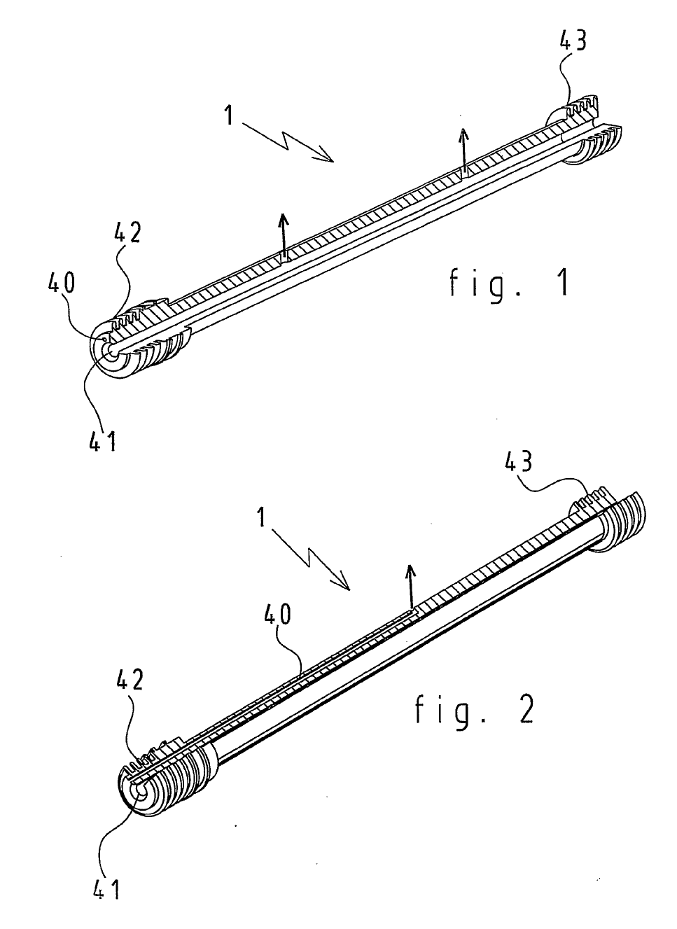

FIG. 1 is a first open view of a probe body for a pressiometer according to the invention;

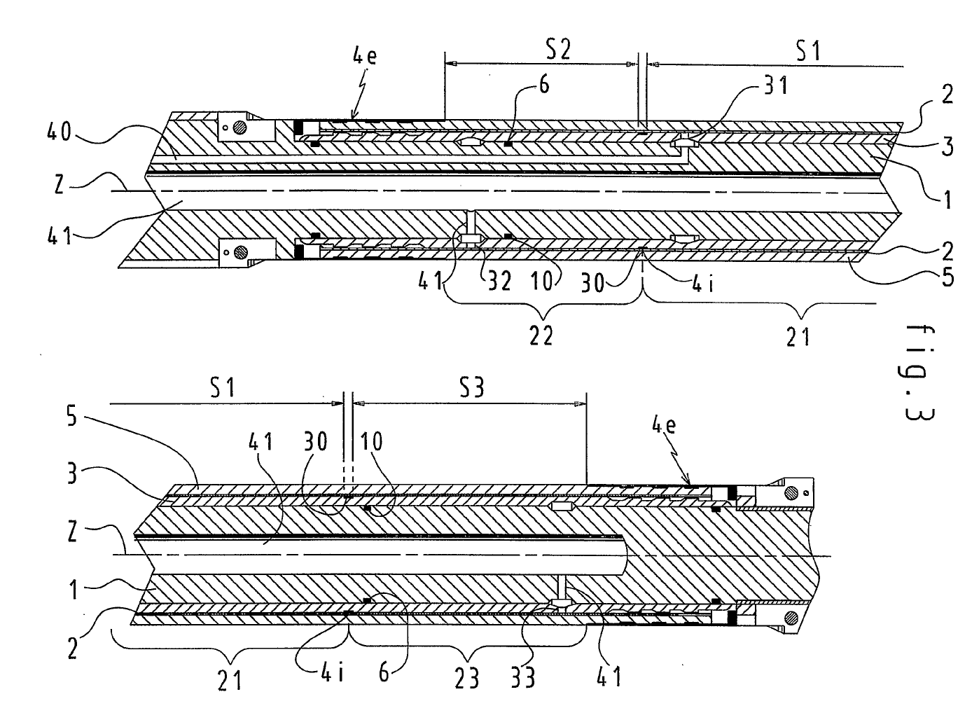

FIG. 2 is a second open view of a probe body for a pressiometer according to the invention;

FIG. 3 is a fractionated and partial axial cutaway view of a probe for a pressiometer according to an embodiment of the invention;

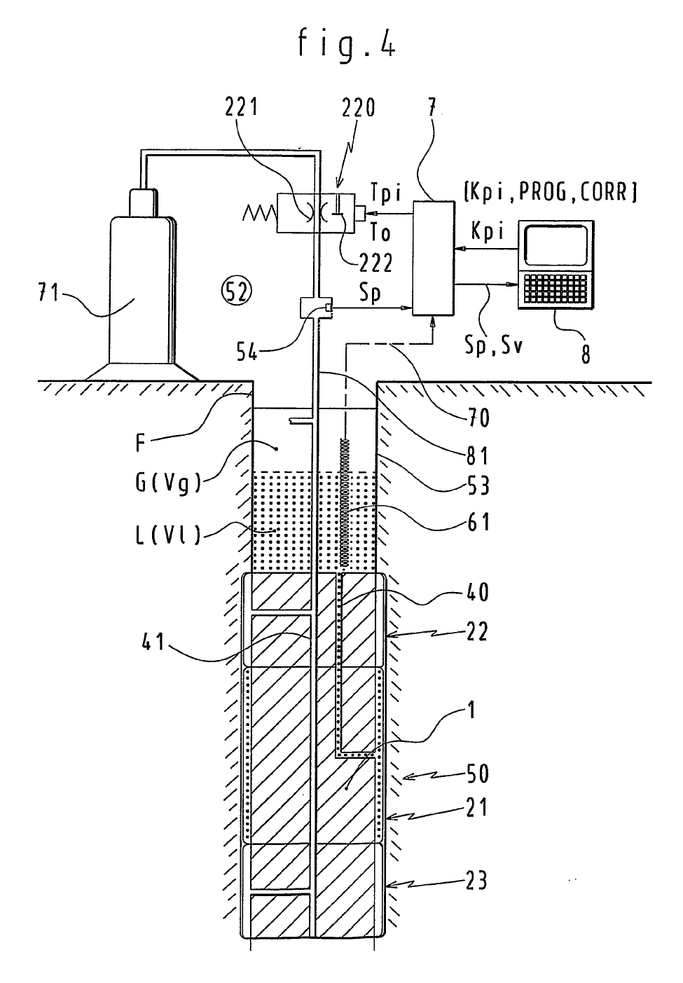

FIG. 4 illustrates a pressiometer that comprises a probe according to the invention.

As illustrated in FIG. 1, the probe body 1 for a pressiometer comprises a first pipe 40 for supplying a first fluid and a second pipe 41 for supplying a second fluid, in an open view. The first pipe 40 for supplying a first fluid is a liquid supply pipe that is designed to supply a central inflatable sleeve, not shown. The second pipe 41 for supplying a second fluid is a gas supply pipe that is designed to supply two inflatable sleeves that are adjacent to the central sleeve, not shown.

The liquid supply pipe 40 and the gas supply pipe 41 have been obtained by piercing the probe body 1.

The two fluid supply pipes 40, 41 are thus located in a filled probe body, while in the traditional probes, these are tubes that are welded into the probe body. The probe body 1 according to the invention makes it possible to avoid the presence of these welds that are fragile and that can give way during drilling under the action of the probe being driven in, or under the action of the pressure of fluids during the pressiometric tests. Better sealing of the supply pipes 40, 41 is thus also ensured.

In addition, the probe body 1 is equipped with two threaded external zones 42, 43, whereby each is arranged at one end of the probe body 1. The threaded zones 42, 43 are equipped with string-type threads. In this way, the transmission of impact forces into the probe is improved.

FIG. 2, where identical elements bear the same references, shows in an open view the pipe 40 for supplying liquid to a central inflatable sleeve, adjacent to the probe body 1 and not shown.

The pressiometric probe that is illustrated in FIG. 3 comprises a probe body 1 and three inflatable annular sleeves 21, 22 and 23.

The probe body 1 extends along the axis Z of the probe and comprises a water supply pipe 40 and a gas supply pipe 41.

The sleeves 21, 22 and 23 surround the probe body 1 and extend respectively over three adjacent and successive longitudinal sections of the probe, referred to as S1, S2 and S3.

The central sleeve 21 is connected to the pipe 40, while the sleeves 22 and 23, which are arranged on both sides of the central sleeve 21, are each connected to the gas supply pipe 41, whereby this gas generally consists of pressurized nitrogen.

The sleeves 21 to 23 are made from a single elastic sleeve 2 that sheathes a hollow cylindrical mandrel 3 that is itself slipped on in a removable and airtight way on the probe body 1, whereby for this purpose, the probe body 1 has an outside surface that is integrated into a cylinder.

More specifically, the mandrel 3 has three fluid openings that are separated from one another in an airtight manner, referred to as 31, 32 and 33, and that open respectively in the three longitudinal sections S1, S2 and S3 of the probe.

The opening 31 of the central section S1 is connected to the water supply pipe 40, while each of the other two openings 32 and 33 is connected to the gas supply pipe 41.

To define the three sleeves 21, 22 and 23 and to form the three corresponding longitudinal sections S1, S2 and S3 of the probe, the elastic sleeve 2 is fractionated by means of hoops such as 4e and 4i that apply it locally and in an airtight way on the outside surface of the mandrel 3.

These hoops comprise in particular two end hoops 4e that each consist of a metal clamping.

The sleeve 2 is covered by a mechanical sheath 5 for deformable protection, for example made of a coated fabric, and the metal clampings 4e are applied on this sheath 5.

The hoops comprise two intermediate hoops 4i that are designed to ensure the separation between the central sleeve 21 and the protective sleeves 22 and 23.

For the purpose of representation size, only the location of the hoops 4i is depicted in FIG. 3. Each of the intermediate hoops 4i advantageously consists of a number of coils of a flexible link that is wound under tension around the sleeve 2, whereby these coils are preferably secured relative to one another and kept under tension by gluing.

To facilitate the placement and the hold of the intermediate hoops 4i, the mandrel 3 preferably has two external peripheral grooves 30, whereby each intermediate hoop 4i can thus apply the elastic sleeve 2 to the bottom of one of these grooves 30.

Finally, the probe is equipped with O-ring seals 6 that are installed in external peripheral grooves 10 of the probe body 1 and that separate from another, in an airtight manner, the three fluid openings 31, 32 and 33 that are made in the mandrel 3.

FIG. 4 shows a pressiometer that comprises a probe 50 that is designed to be inserted into a drilling F, a piece of surface equipment 52, and connection means, making it possible in particular to connect the probe 50 to the piece of equipment 52.

The probe 50 comprises three inflatable sleeves, namely a primary and central sleeve 21, and two auxiliary sleeves 22 and 23, adjacent to the central sleeve 21 and located on both sides of the latter.

The primary sleeve 21 is essentially formed by an annular elastic membrane that can be inflated by injection of a pressurized liquid L, for example water, obtained from a tank 53 and channeled by a water supply pipe 40. The pipe 40 is produced by piercing in the probe body 1.

The probe also comprises a tank 53, for example made in a metal cylinder that is essentially non-deformable to the pressures being considered, so that the variation of liquid volume in the tank 53 is only due to the deformation of the central sleeve 21. The tank 53 contains, above the liquid L, a propulsion gas G such as pressurized nitrogen, whereby the liquid and the gas occupy respective and additional volumes Vl and Vg of this tank 53.

The piece of surface equipment 52 typically comprises a gas source 71 that is suitable for delivering pressurized gas G and is connected to the gas volume Vg of the tank 53 via a gas supply pipe 81.

The piece of surface equipment 52 also comprises flow monitoring means, such as 220-222, which are placed on the pipe 81 and which make it possible to monitor the passage of the gas G from the source 71 to the tank 53, and therefore the passage of the liquid L from the tank 53 to the sleeve 21 through the pipe 40.

The pressiometer also comprises a pressure sensor 54 and a volume sensor 61, whereby the pressure sensor 54 is designed to provide a signal Sp that is linked to the pressure of the liquid L in the tank 53, and the volume sensor 61 is designed to provide a signal Sv that is linked to the volume Vl of the liquid in the tank 53.

The volume sensor 61 comprises a liquid level detector that is housed in the tank 53, whereby this tank is carried by the probe 50 and arranged above the probe body 1 when the probe 50 is placed in a drilling F.

A transmission link 70 is then provided to connect the level detector 61 to the piece of surface equipment 52, whereby this link consists of, for example, an electrical line in the advantageous case where the volume signal Sv is electrical in nature.

In one effective embodiment of the invention, the level detector 61 is of the resistive type.

The pressure sensor 54 can be arranged in the gas phase of the contents of the tank 53, and in particular in the pipe 81 for supplying gas G.

The auxiliary inflatable sleeves 22 and 23 are selectively inflated by the gas G, and connected for this purpose by a pipe 41 to the volume Vg of the gas G of the tank 53. The pipe 41 is made by piercing in the probe body 1.

The precision of the pressiometer of the invention can also be increased by equipping the piece of surface equipment with pressure guiding means and by providing that the flow monitoring means comprise a nozzle 221 and a valve 222, for example integrated in a solenoid valve 220.

In the illustrated embodiment, the pressure guiding means comprise a control unit 7 that is suitable for activating the valve 222, and a computer 8 that is connected to the control unit 7 and that guides it.

The computer 8 is equipped with a memory in which the following are stored: a number of pressure set points for increasing values Kpi, a program PROG for successive application of these set points Kpi over time, and a correspondence law CORR that makes it possible to determine, at least on the basis of the set points Kpi, corresponding respective time intervals Tpi.

1-11. (canceled)

12. Geotechnical or geophysical probe (50) of the type that comprises a central probe body (1) that is designed to supply, in one or more fluids (G, L) contained in a tank (53) and using one or more pipes (40, 41) for supplying fluids (G, L), at least one element of the probe (21, 22, 23) that is adjacent to the probe body (1), said pipes (40, 41) for supplying fluids (G, L) comprising a first supply pipe (40) and a second supply pipe (41), characterized in that it comprises an essentially non-deformable tank (53), arranged in an operational configuration of the probe above the probe body (1) and designed to contain additional volumes (Vg, Vl) of a first fluid (L) and a second fluid (G), whereby the volume (VI) of the first fluid of the tank (53) is linked with at least one first supply pipe (40), whereby the volume (Vg) of the second fluid (G) of the tank (53) is at least connected to the second supply pipe (41), whereby the pipes (40, 41) are made by piercing in a filled zone of the probe body (1).

13. Probe (50) according to claim 12, wherein the fluid-supplied elements comprise a central inflatable sleeve (21), two inflatable sleeves (22, 23) that are adjacent to the central sleeve (21) and located on both sides of the latter, whereby the three sleeves (21, 22, 23) surround the probe body (1), the central sleeve (21) is connected to the first pipe (40) for supplying the first fluid (L), and the sleeves (22, 23) that are adjacent to the central sleeve (21) are connected to the second pipe (41) for supplying the second fluid (G).

14. Probe (50) according to claim 12, wherein the first fluid (L) and the second fluid (G) are respectively a liquid and a gas.

15. Probe (50) according to claim 12, wherein the probe body (1) is cylindrical and is equipped with one or more external threaded zones (42, 43).

16. Probe (50) according to claim 15, wherein the external threaded zones (42, 43) are arranged at each of the ends of the probe body (1).

17. Probe (50) according to claim 15, wherein the threads are of the string type.

18. Probe (50) according to claim 12, wherein the tank (53) comprises a volume sensor (61) that is suitable for providing a signal (Sv) that is linked to the volume (Vl) of the liquid in the tank (53).

19. Probe (50) according to claim 18, wherein the volume sensor (61) comprises a liquid level detector.

20. Pressiometer, wherein it comprises:
A probe (50) according to claim 12,
A piece of surface equipment (52) that comprises a source (71) of pressurized gas, a pipe (71) that connects the gas source to the tank (53) of the probe (50), a pressure sensor (54) that is suitable for providing a signal (Sp) that is linked to the pressure in the tank (53) of the probe (50), and
Means for connecting the probe (50) to the piece of surface equipment.

21. Probe (50) according to claim 13, wherein the first fluid (L) and the second fluid (G) are respectively a liquid and a gas.

22. Probe (50) according to claim 13, wherein the probe body (1) is cylindrical and is equipped with one or more external threaded zones (42, 43).

23. Probe (50) according to claim 14, wherein the probe body (1) is cylindrical and is equipped with one or more external threaded zones (42, 43).

24. Probe (50) according to claim 16, wherein the threads are of the string type.
